(19) United States
(12) Patent Application Publication
(10) Pub. No.: US 2015/0086813 A1
(43) Pub. Date: Mar. 26, 2015

(54) REVERSE ELECTRODIALYSIS ENERGY GENERATING SYSTEM USING CAPACITIVE ELECTRODES AND METHOD THERE FOR

(71) Applicant: Stichting Wetsus Intellectual Property Foundation, Leeuwarden (NL)

(72) Inventors: David Arie Vermaas, Leeuwarden (NL); Joost Veerman, Leeuwarden (NL); Machiel Saakes, Leeuwarden (NL)

(21) Appl. No.: 14/387,621

(22) PCT Filed: Mar. 25, 2013
(86) PCT No.: PCT/NL2013/050215

§ 371 Date: Sep. 24, 2014

(30) Foreign Application Priority Data
Mar. 26, 2012 (NL) 2008538

(51) Int. Cl. H01M 16/00; H01M 12/02; H01M 8/04

(52) U.S. Cl. CPC H01M 16/003; H01M 8/04753; H01M 12/02
USPC 429/9; 429/51

(57) ABSTRACT

An energy generating system using capacitive electrodes and a method therefore are disclosed. In an embodiment, the system includes first electrode and a second electrode compartments. A number of electrolyte compartments are provided between the first and second compartments. The compartments are formed by a number of alternately provided cation exchange membranes and anion exchange membranes. In use, the electrolyte compartments are alternately filled with a high and low osmotic flow, such that the first and second electrodes are charged with positively or negatively charged ions. A circuit is connected to the at least first and second electrodes for collecting the generated energy; and a switching device is included for switching between the high and low osmotic flows such that the system switches from a first energy generating state to a second energy generating state with the first and second electrodes switching polarity.

The present invention relates to an energy generating system using capacitive electrodes. More specifically, the system generates energy in the form of electric power using fluids of high and low osmotic flows. The concentration differences between the fluids create a potential difference enabling the generation of energy.

Systems and processes performing an electrodialysis operation are known, for example from WO 2010/110983. These electrodialysis operations aim at desalination of water. For this desalination the operation requires a power source connecting the electrodes thereby using energy. In addition, WO 2010/110983 only describes electrodialysis under specific conditions, such as the wash stream has a closed loop and should contain calcium sulphate, there is a supersaturation of calcium sulphate in the range of 1 to 3, the flow velocity in the wash stream is at least 5 cm/s, and a precipitation unit is required.

NL 1031148, WO 2010/062175 and WO 2010/143950 disclose an energy generating system that uses a reverse electrodialysis process, or a similar process, wherein a number of anion and cation exchanging membranes are alternately provided between two electrodes. In use the compartments formed between the different adjacent membranes are filled with a fluid. Adjacent compartments are filled with a fluid having a different salt concentration such that ions tend to move from the high concentration fluid to the low concentration fluid. Anions can only pass through the anion exchanging membranes and cations can only through the cation exchanging membranes. This provides for a net transport of cations and anions in different directions. At the electrodes redox reactions take place to maintain the electric neutrality of the fluids. These redox reactions facilitate the conversion from an ionic current to an electric current such that electric energy is generated. Redox reactions can be non-reversible or reversible.

Non-reversible redox reactions require a significant potential. Examples include the electrolysis of water into H₂ and O₂ and the generation of H₂ and Cl₂. This reduces the net obtainable electrical power. In addition, gas bubbles may increase the electrical resistance of the electrolyte. Furthermore, the production of H₂ and Cl₂ requires additional safety measures thereby complicating the process.

Using reversible redox reactions involves special treatments to prevent precipitation or losing the chemicals used in the reactions. An example of such reversible redox reaction involves [Fe(CN)₆]³⁻/[Fe(CN)₆]⁴⁻ that may form complexes with Fe³⁺ and may become unstable when subject to heat or UV. The use of Fe²⁺/Fe³⁺ requires a relatively low pH of about 2.3 or less to prevent precipitation of iron (hydr)oxides. In practice, leakage through and around the membranes surrounding the electrode compartment will slowly dilute the redox couples thereby decreasing its performance.

An object of the invention is to obviate the above mentioned problems and to achieve an effective and efficient energy generating system.

This object is achieved with the energy generating system using capacitive electrodes according to the invention, the system comprising:
a first electrode compartment provided with at least a first capacitive electrode capable to store ions and conduct electrons;
a second electrode compartment provided with at least a second capacitive electrode capable to store ions and conduct electrons;
a number of electrolyte compartments provided between the first and the second electrode compartments, wherein the electrolyte compartments are formed by a number of alternately provided cation exchange membranes and anion exchange membranes, whereby in use the electrolyte compartments are alternately filled with a high and low osmotic flow, such that the first and second electrodes are charged with positively or negatively charged ions;
a circuit connected to the at least first and second electrodes for collecting the generated energy; and
switching means for switching between the high and low osmotic flows such that the system switches from a first energy generating state to a second energy generating state with the first and second electrodes switching polarity.

The capacitive electrode comprises a current collector and an element capable to store ions and conduct electrons. In a presently preferred embodiment this element comprises activated carbon. This activated carbon can be provided on a suitable current collector, typically graphite, titanium or coated titanium, by for instance casting, painting, coating, or extruding a mixture coating at least high surface area particles, such as activated carbon, and a binder. In addition to the activated carbon and a binder, a solvent and additives such as, conductive materials such as graphite or carbon black can be added to the mixture. As one of the possible examples, the activated carbon can be provided on the current collector by casting or painting a carbon suspension in a solvent. In a presently preferred embodiment activated carbon is used as a capacitive element with a thickness of the activated carbon layer in the range of 10-10000 micrometer.

The capacitive electrodes of the system according to the invention are capable of storing a significant surplus of either cations or anions in its porous structure and therefore store a net electrical charge. This would not be possible with conventional (non-capacitive) electrodes. In the capacitive electrodes the charge is balanced by electrons, which are stored in a conductive part of the electrode. The capacitive electrode can transfer an ionic current into an electrical current without the presence of a redox reaction. In addition, this enables the capacitive electrodes as used in the system according to the invention to use the stored charge in a later stage, as self-discharge in the capacitive electrodes is kept to a minimum, to facilitate the electricity production.

The capacitive electrodes for this invention, acting as super-capacitors, can be either double layer capacitors or pseudo-capacitors (or a hybrid capacitor). The current collector should be a conductive material, such as graphite, expanded graphite foil, metals such as titanium and titanium with a protective platinum coating or glassy carbon or combinations thereof. Glassy carbon has the advantage that the surface can be made porous by a heat activation treatment, thus creating a capacitive layer directly on the current-collector. Conductive diamond, which can be made porous, is another interesting capacitive electrode material because of its very wide potential window. In other cases, a capacitive material can be placed on top of the current collector. As ingredients for capacitive materials, one can choose for example activated carbon that is used in a presently preferred embodiment according to the invention, or carbon nanotubes, graphene or metal oxides such as MnO₂, RuO₂ or Ru/Ir-mixed oxides. The carbon nanotubes, graphene and metal oxides can be used with or without activated carbon. The capacitive electrodes as used in a presently preferred embodiment according to the invention have a capacity of at least 1000 Farad per m² of electrode for an effective operation.

The system comprises at least two capacitive electrodes in between a number of cation and anion exchanging membranes that are alternately provided. Electrolyte compartments are formed in the spaces between two adjacent membranes. Two adjacent membranes, i.e. one anion exchanging membrane and one cation exchanging membrane, and two electrolyte compartments define one reverse electrodialysis cell.

The system according to the invention generates energy, while a conventional electrodialysis system has a power source that connects the electrodes. As a consequence, the element that operates as a cathode in electrodialysis operates as an anode in reverse electrodialysis (while leaving the concentrated and diluted water in the same compartments). Moreover, the typical modes of operation and typical geometries of a system according to the invention capable of generating energy are in another range as to electrodialysis. For example, the typical current density for a system according to the invention, being the high osmotic flow concentrations that are typical for seawater, is in the range between 0-100 A/m², and most preferred between 10-50 A/m². For higher concentrations this range would approximately be double, so most preferably 20-100 A/m². For example, the current density in electrodialysis is typically an order of magnitude larger, which, as will be understood, has major consequences for the operation of the capacitive electrodes. In addition, the typical distance between the membranes in a system according to the invention is up to 500 micrometer, and most preferred up to 300 micrometer. The intermembrane distance in electrodialysis is typically several times larger than this value. Also, the typical flow velocity of the feed water in a system according to the invention is between 0-5 cm/s, and most preferred between 0-2 cm/s. The typical flow velocity in electrodialysis is outside this range and typically between 5-100 cm/s. In a number of relevant cases the concentration of the diluted feed flow in electrodialysis is typically an order of magnitude larger than that in a system according to the invention. Another effect of the process with the system according to the invention is the prevention or reduction of adverse effects as compared to electrodialyses processes such as supersaturated solutions including in the boundary layers close to the membranes.

In comparison to conventional systems for energy generation from high osmotic and low osmotic flows, a system according to the present invention, in use, provides a salt water body that is present between the capacitive elements and the membrane, which is relevant to enable large storage of positive as well as large storage of negative charge on each electrode. In addition, in a presently preferred embodiment according to the invention concentrated and diluted salt solutions flow continuously and in multiple cells, which greatly enlarge the electromotive force. Therefore, more charge can be stored on the electrodes in each cycle and a higher (average) power density is obtained.

In a presently preferred embodiment the number of membranes is twice the number of cells and one. This means that both electrodes on different sides of the stack of membranes face the same type of membrane, i.e. a cation exchanging membrane or anion exchanging membrane, as closest membrane. The number of electrolyte compartments is at least two or more, as two adjacent electrolyte compartments are filled with flows having a high and low osmotic flow, preferably a fluid having a low salinity and a high salinity respectively. This difference in osmotic pressure drives the ions in the fluid towards an adjacent compartment in a direction that is determined by the type of membranes. The origin of these fluids can be naturally, artificial, industrial waste or combinations of these. Examples include the following combinations: sea water with river water, RO concentrate with sea water, industrial brine with river water. A special application of this invention is in so called “closed systems” where an external energy source is used to regenerate the fluids. The high and low osmotic flows can contain different salts. The concentration of these salts in the concentrated solution should preferably be in the range between 0.25 M and the concentration at which the solution is saturated, but most preferred between 0.4 M and 3 M. The diluted solution has always a lower concentration than the concentrated solution. The high and low osmotic flows preferably are concentrated and diluted salt solutions. These flows are readily available at most locations such that an efficient energy generating system can be achieved.

In the electrode compartments wherein the capacitive electrodes are provided the ions tend to accumulate. Providing a circuit connecting the at least two capacitive electrodes drives the ions of a specific type, i.e. cations or anions, towards the capacitive electrode that stores this specific type of ions. Electrons from an external circuit provide electro-neutrality. As a consequence electric energy will be generated through the circuit.

To discharge the capacitive electrodes, and maintain the energy generating capability of the system, switching means switch the system between a first energy generating state to a second energy generating state by switching the flows having high and low osmotic flow, preferably high and low salinity, in position. This means that an electrolyte compartment that in a first state is filled with a low osmotic flow in a second state is filled with a fluid having a high osmotic flow and vice versa.

The switching of flows with high and low osmotic solutions can be controlled by valves. The valves are preferably switched at the same time, assuming that the flow channels of both flows are similar, such that the flow with high osmotic solution enters the compartments that where previously filled with low osmotic flow and vice versa. In one of the preferred embodiment according to the present invention reference electrodes and/or pH-sensors can indicate the correct moment for switching the high and low osmotic flows, as described later in this description. These sensors can be used either as monitor or can be connected to an electrical circuit that automatically activates the switching means when the sensors indicate the correct moment for switching.

Also, switching between the different states means the first and second electrodes switch polarity such that the electrode that in a first state is charged with anions in a second state discharges the anions and is charged with cations. Both states generate electric energy. This may involve a switch in the circuit connecting the at least two capacitive electrodes and a load. The frequency at which the switching takes place is determined by the capacity of the capacitive electrodes. In fact, the voltage that is required to store additional charge on the electrodes gradually increases. This voltage can be measured as the difference between the voltage over the stack as a whole and the voltage over the membranes only. The voltages over the membranes only, can be controlled by reference electrodes connected to the electrode compartments. When this voltage difference, i.e. the voltage to store additional charge, is close to the voltage that may cause electrolysis, which is about 1.2 Volt, or close to the voltage that is produced by the cells, the direction of the electric current should be switched by the switching means. By switching the fluid or feed waters the electromotive force generated by the flows switches such that the direction of the generated electric current also switches together with the direction of the ions.

The effect of using capacitive electrodes and switching the flows is that redox reactions are not required. This saves the required over-potential when a non-reversible redox reaction is used such that a higher power density is achieved. In addition, the system according to the invention does not require the use of added chemicals for redox reactions and has minimal risk of precipitation thereby achieving an effective and efficient energy generating system.

In addition to the absence of redox reactions water splitting is prevented in the system according to the invention due to the more or less constant pH in the electrode compartment, saving the stored charge in the capacitive electrodes that can be used in the next state achieving a high efficiency.

A further advantage of the system according to the present invention is that the ratio between the number of cells and the number of electrodes is relatively high. This means that a cost effective system can be achieved.

In a presently preferred embodiment a single cell provides about 0.15 Volt such that eight cells for provide about 1.2 Volt, and 30 cells provide about 4.5 Volt, for example. The voltage over an individual electrode only, however, is independent of the number of cells. Due to this higher voltage, in case of multiple cells, the transported charge is no longer limited by the voltage over one individual cell, and hence the time period between two switches can be increased such that the efficiency of the system is further improved.

The number of cells in a presently preferred system according to the invention is between 1-10000 cells, and more preferably between 100-2500 cells. The charge per cycle per electrode area preferably is in the range of 0-1000000 Coulomb/m², and more preferably in the range of 50000-500000 Coulomb/m². The preferred switching time is in the range of 0-1000 minutes, and more preferably in the range of 30-500 minutes, with a preferred capacity per electrode area of 1000-500000 Farad/m², and more preferably of 10000-500000 Farad/m². The preferred current density, or in other words current per electrode area, is between 0-200 A/m², and more preferably 10-100 A/m². It is noted that this current density in electrodialysis systems typically is in the range of 100-1000 A/m².

In a presently preferred embodiment according to the present invention in use the electrode compartments are filled with rinse solution.

Providing a rinse solution enables ions to move through the electrode compartment to and from the capacitive electrode. A rinse solution preferably comprises dissolved salt.

The rinse solution preferably is the high or low osmotic flow, most preferably a mixture thereof. As these flows are already available, in a presently preferred embodiment no separate pump and flow circuits are required thereby achieving a cost effective system. Optionally, the at least two electrode compartments can be provided with different fluids.

In a further preferred embodiment in use the electrolyte solution in a compartment is alternately the high and low osmotic flow. This means that the capacitive electrodes alternately face the concentrated and diluted fluids saving a circulation of a separate electrode rinse solutions and, furthermore, saving two membranes. This further improves the power density per membrane. The fluids or flows in the electrode compartment switch together with the flows through the electrolyte compartment.

In a preferred embodiment according to the present invention the rinse solution substantially remains within the electrode compartment.

Maintaining the rinse solution in the electrode compartment within this compartment simplifies the overall system as no flow is required. Preferably, in use, the electrode compartments comprise a fluid with dissolved salt. In fact, in a presently preferred embodiment the electrodes and corresponding electrode compartments comprise a salt solution. This means that a salt solution is provided within or at the electrode.

In a further preferred embodiment according to the present invention the switching means comprise a first reference electrode in the first electrode compartment and a second reference electrode in the second electrode compartment.

By providing reference electrodes the voltage over an individual capacitive electrode can be monitored. The reference electrodes, for example Ag/AgCl electrodes or calomel electrodes, are connected to both electrode compartments, filled with electrode rinse solution. When the difference between the voltage over the total stack and the voltage over the reference electrodes exceeds the voltage that is required to facilitate redox reactions (such as electrolysis), switching is preferred. By this means, an indication is provided when the switching of the flows should be performed. This further improves the overall efficiency of the energy generating system.

Additionally or alternatively, the switching means of the energy generating system according to the invention comprise a pH-sensor. The pH will be more or less constant when redox reactions are absent. When the capacitive electrodes are fully charged and redox reactions will occur, the pH will change. Therefore, the pH-sensor also provides an indication when the switching of the different osmotic flows should be performed.

The invention further relates to a method for generating energy, the method providing an energy generating system as described above, providing flows with high and low osmotic flow, preferably flows with high and low salinity, in adjacent electrolyte compartments, and switching from a first generating state to a second generating state wherein the high and low osmotic flows, preferably the flows with high and low salinity, change position.

The same effects and advantages apply for the method as described for the energy generating system.

An additional advantage of the present invention that distinguishes from electrodialysis, is that the energy generation can continue directly after the switch of seawater and river water. Although it takes some time to reach a maximum power again, power can be generated when the stack voltage is either positive or negative. In electrodialysis, a pause is required to prevent mixed water in the product stream. The continuous power production significantly increases the overall performance of the system and method according to the invention. Furthermore, the method according to the invention enables a net production of energy.

Further advantages, features and details of the invention are elucidated on the basis of preferred embodiments thereof, wherein reference is made to the accompanying drawings, in which:

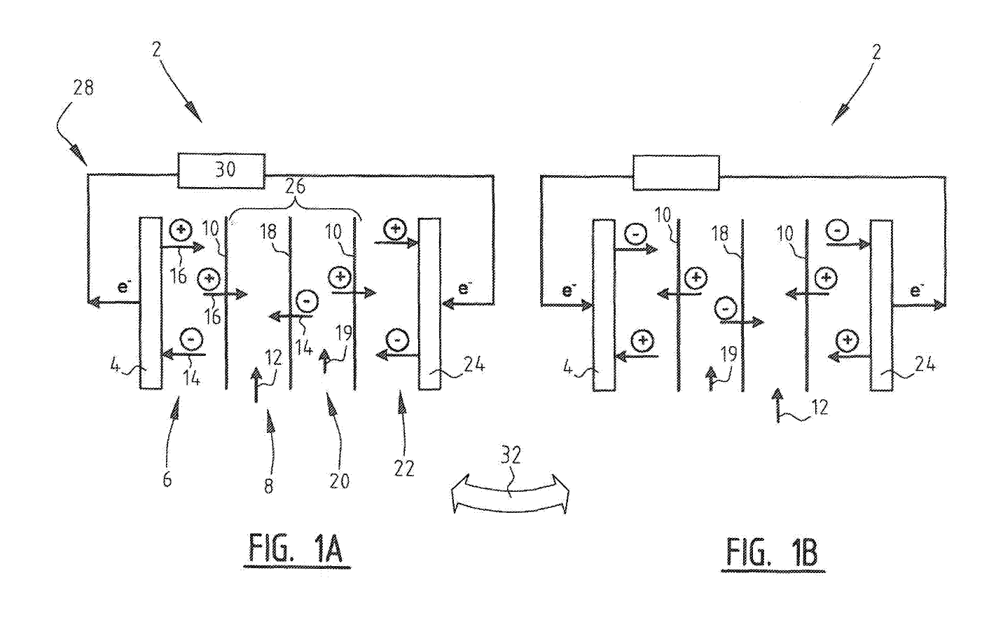

FIGS. 1A-B show a system according to the invention in two states;

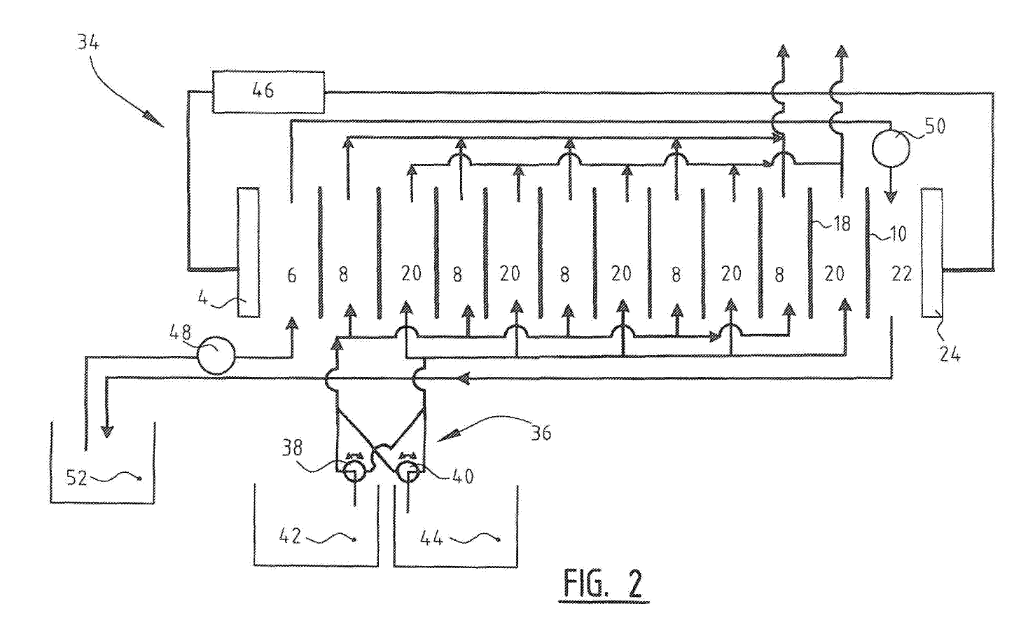

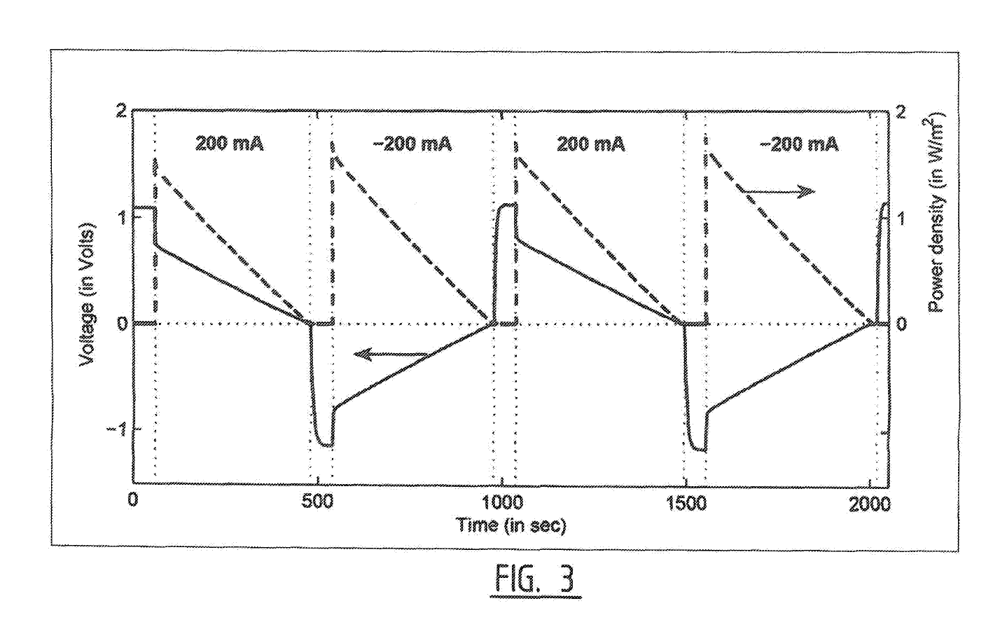

FIGS. 2-3 show an alternative system according to the present invention and results achieved therewith;

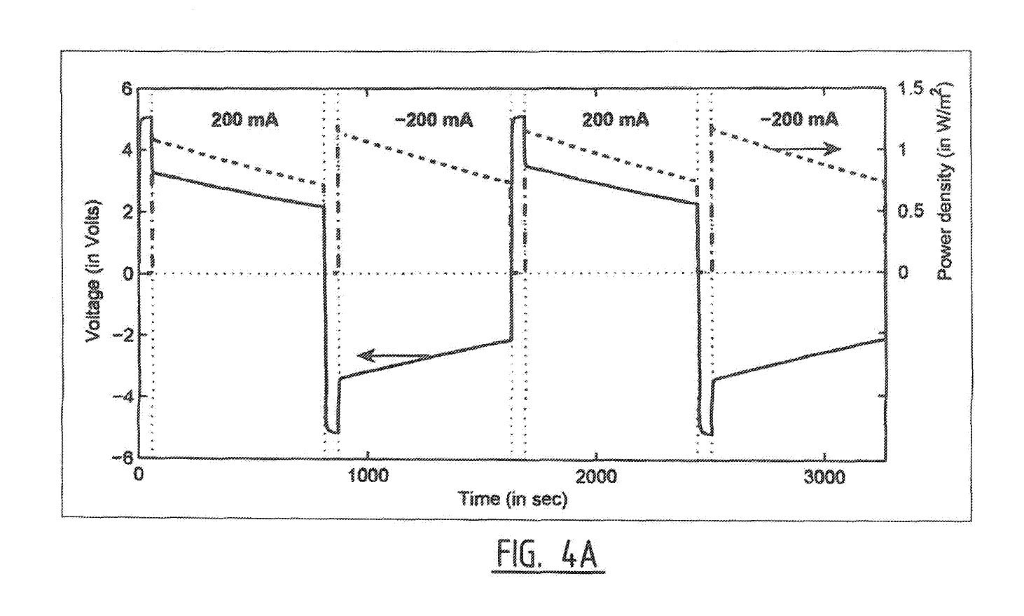

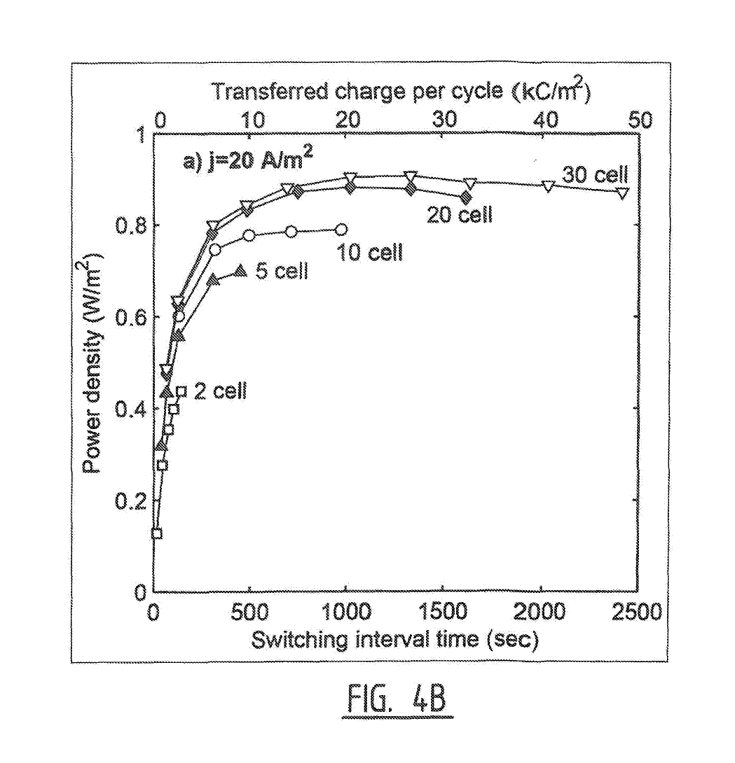

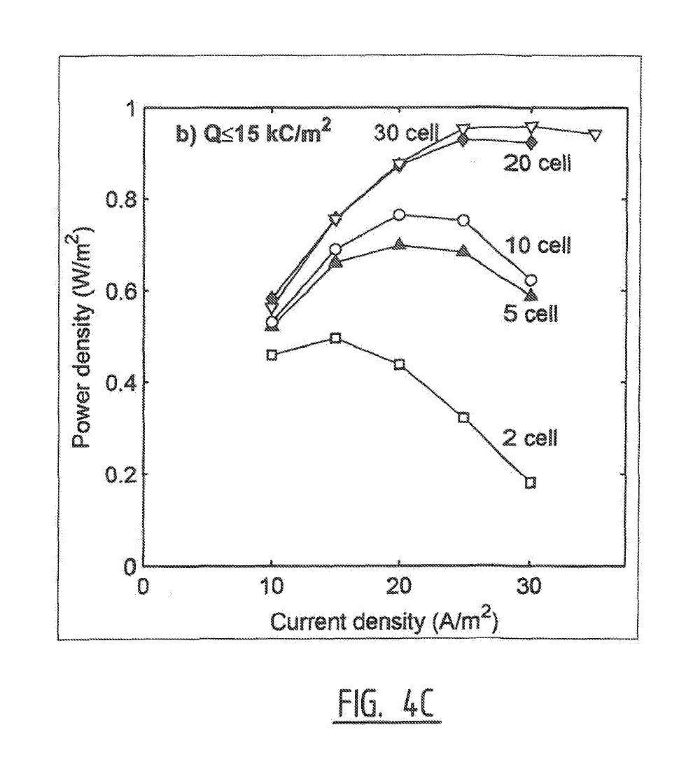

FIG. 4A-C shows results achieved with an embodiment of the system according to the invention having 30 cells;

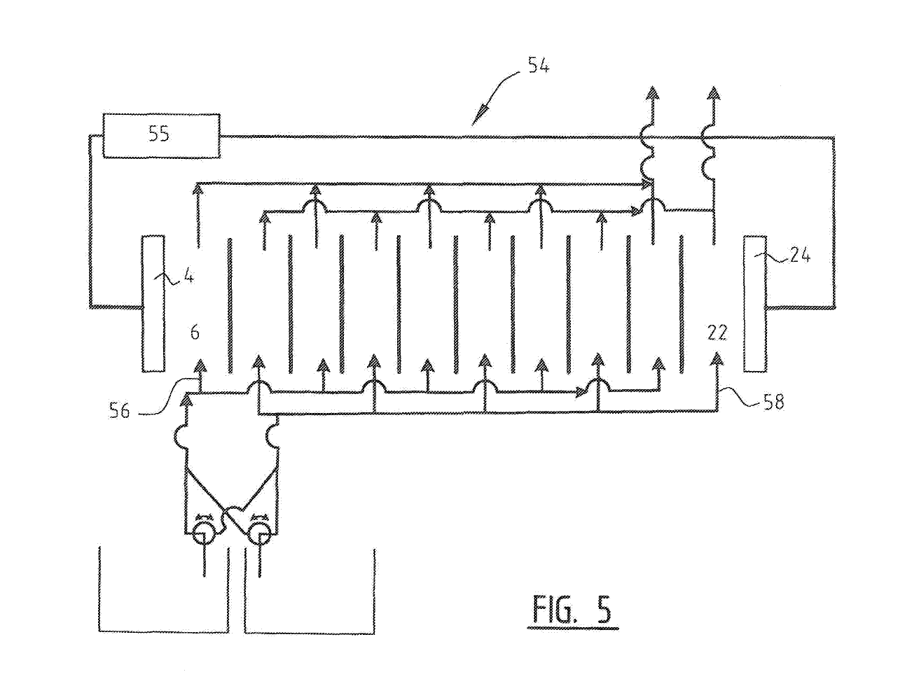

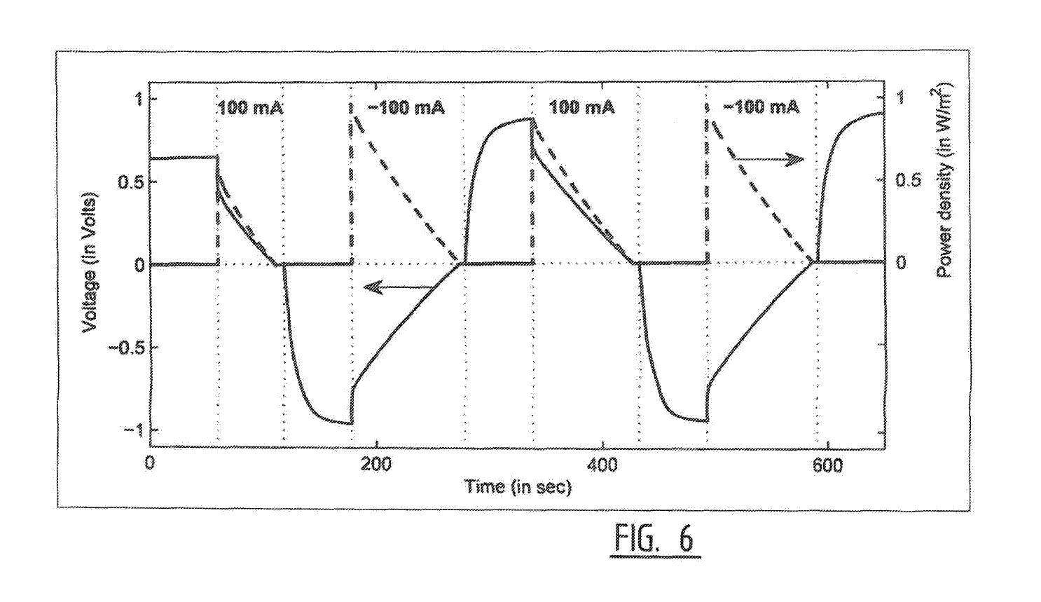

FIGS. 5-6 show a further alternative embodiment of the system according to the present invention and results achieved therewith; and

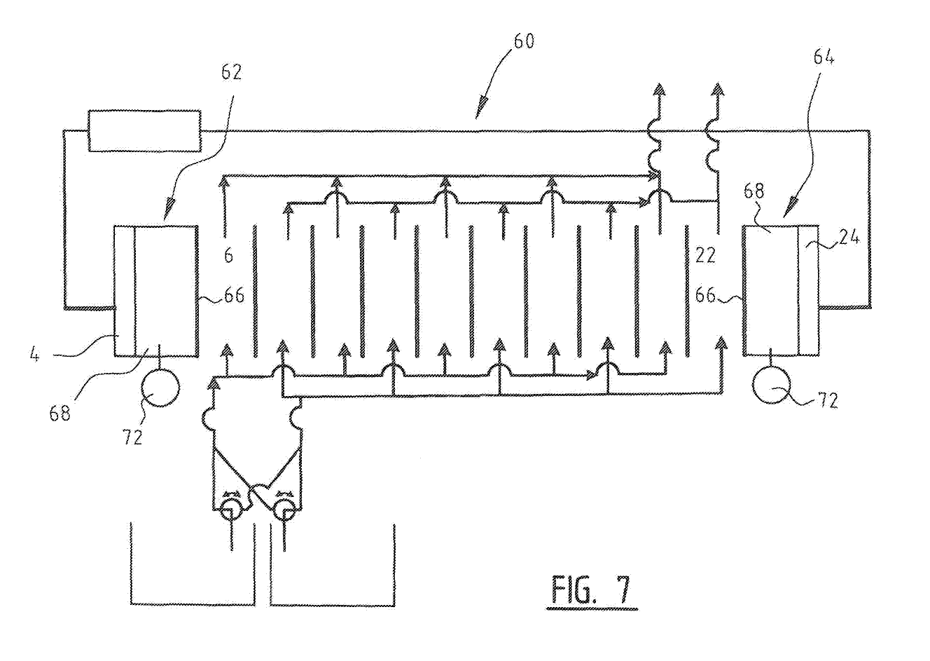

FIG. 7 shows a further alternative embodiment according to the present invention.

An energy generating system 2 (FIGS. 1A-B) comprises a first capacitive electrode 4 that is placed in electrode compartment 6. An electrolyte compartment 8 is separated from first electrode compartment 6 by membrane 10. In the illustrated embodiment membrane 10 is a cation exchanging membrane. In the first energy generating state (FIG. 1A) a concentrated salt solution 12 flows through electrolyte compartment 8. Cations 16 migrate through cation exchange membrane 10 while anions 14 migrate through an anion exchanging membrane 18. A diluted salt solution 19 flows through electrolyte compartment 20. Membrane 18 separates electrolyte compartment 8 from electrolyte compartment 20. In the illustrated embodiment a second electrode compartment 22, wherein a second capacitive electrode 24 is placed, is separated by membrane 10. Compartments 8, 20 and two membranes 10, 18, one of each type, together form cell 26. Electrodes 4, 24 are externally connected via circuit 28 wherein load 30 is provided.

Switching means 32 switches system 2 between a first state (FIG. 1A) and a second state (FIG. 1B). In the second state flows 12, 19 change position. This means that in a second state diluted salt solution 19 flows through electrolyte compartment 8 and concentrated salt solution 12 flows through electrolyte compartment 20. This means that the flow of anions and cations 14, 16 tend to move in opposite direction as compared to the first state. Also the flow direction of the electrons in circuit 28 is in an opposite direction.

In a first state (FIG. 1A) flows 12, 19 are started. Ions tend to move through membranes 10, 18. This results in a charge of electrodes 4, 24. Capacitive electrode 4 is being charged with anions 14 and second capacitive electrode 24 is charged with cations 16. Electrons flow through circuit 28 via load 30 from first capacitive electrode 4 towards second capacitive electrode 24. After the capacitive electrodes 4, 24 have been charged switching means 32 switch system 2 to a second state (FIG. 1B) wherein flows 12, 19 change position. The net flow of cations 16 and anions 14 is in opposite direction as compared to the first state such that the direction of the flow of electrons in circuit 28 is also opposite. First, capacitive electrodes 4, 24 are being discharged and, next, electrodes 4, 24 are charged with cations for capacitive electrode 4 and anions for capacitive electrode 24.

An energy generating system 34 (FIG. 2) comprises a number of electrolyte compartments 8 and electrolyte compartments 20. In fact, in the illustrated embodiment five cells 26 have been provided between the capacitive electrodes 4, 24. Switching means 32 comprise switching device 36 comprising first valve 38 and second valve 40 that direct the flow of the respective concentrated salt solution and diluted salt solution 44 towards the electrolyte compartments 8, 20. Switching device 36 switches the valves such that when system 34 operates in a different state the flows change position.

To perform an experiment a galvanostat 46 is provided in the circuit between capacitive electrodes 4, 24. Electrode compartment 6 comprises a reference electrode 48 and electrode compartment 22 comprises a second reference electrode 50. Electrode compartments 6, 22 are provided with electrode rinse solution 52. In the illustrated embodiment that is used in an experiment capacitive electrodes 4, 24 comprise a titanium mesh 1.7, which is woven, or alternatively non-woven, and has a yarn diameter or strand width of approximately 1.5 mm, a mesh opening of approximately 5 mm and a surface area of 10 by 10 cm. Electrodes 4, 24 are provided with a coating of platinum of about 50 g/m². The electrodes 4, 24 comprise a mixture of carbon (Norit DLC super 30), polyvinylidene fluoride polymer and N-methylpyrrolidone dipolar solvent that was casted on the mesh using a doctor blade. The capacitive electrodes were embedded in an end plate made from PMMA. The end plate comprises an inlet and outlet for electrode rinse solution. First electrode 4 was provided with a 1 mm thick gasket to create a compartment for the electrode rinse solution and seal the electrode solution from leaking. Cation exchange membrane 10 was Neosepta CMX, anion exchange membrane 18 was Neosepta AMX, and a spacer and gasket of 200 micrometer thick were used. Additional cation exchange membrane 10 closes the last cell after which a second electrode 24 was provided. This specific system of configuration 34 is used in an experiment using a concentrated salt solution of 0.51 M NaCl and a diluted solution of 0.017 M NaCl at a temperature of about 25° C., which were supplied at a flow rate of 20 ml/minute per cell, which corresponds to a flow velocity of 1.7 cm/s. In the experiment the electrode rinse solution of 0.25 M NaCl was circulated at a flow rate of 100 ml/minute. Galvanostat 46 was used in the experiment and a voltage over the complete stack including electrodes 4, 24 was measured. The results of the experiment are shown (FIG. 3 for two subsequent cycles, wherein the solid line showing the voltage over the stack in Volts, the dashed line showing the power density in W/m², and the dotted lines indicating the periods with electric current of about 200 mA and without electric current, with time in seconds). The electrical current was 200 mA, corresponding to 20 A/m². The current was stopped as the resulting voltage approached zero after which the system was switched. After about one minute the current was imposed again in opposite direction.

The experiment was repeated using 30 cells with switching taking place when the voltage over the capacitive electrodes has reached 1 volt. This voltage is equal to the total voltage over the stack minus the voltage over the cells. The voltage over the cells was measured using two Ag/AgCl reference electrodes that were connected to the electrodes in the electrode compartments. Results achieved with this experiment with 30 cells are shown (FIG. 4A, wherein the dashed line showing power density in W/m², solid line showing the voltage over the stack in Volts, and the dotted lines indicating the periods with and without current of about 200 mA, with time in seconds). Water splitting was prevented by switching between states at about 1 Volt. This was enhanced by maintaining a more or less constant pH and the absence, or at least only minimal presence, of free chlorine.

It has been shown that the energy generating system according to the present invention works for short and long cycle times and for several current densities.

Additional experiments were performed that confirm the above results. The average power densities from additional experiments (FIGS. 4B and C) are shown for embodiments with 2, 5, 10, 20 and 30 cells with increasing power density. FIG. 4B shows the average power density as function of switching interval at a current density of 20 A/m². FIG. 4C shows the average power density when feed waters are switched when 15 kCoulomb/m² was transferred or when the voltage reached 0 V. For clarity reasons, the standard deviations are not shown, but are typically less than 5% of the mean value. The switching time varies from a few seconds to 40 minutes (cycle time of 82 minutes) for the results shown in FIG. 4B and the current density varies van 10 to 35 A per m² of electrode for the results shown in FIG. 4C.

The maximum power is obtained at a switching time corresponding to a transferred charge of approximately 20000 Coulomb/m². The highest power densities were obtained at 30 A/m². It will be understood that when different membranes, different feed water concentrations, another number of cells and/or different capacitive electrodes are used, the optimum switching time and optimum current density will be different and can be designed in accordance with the specific application.

In an alternative system 54 (FIG. 5) electrode compartment 6 was provided with rinse solution 56 that in the illustrated embodiment originates from the concentrated salt solution while the second electrode compartment 22 is provided with flow 58 that in the illustrated embodiment originates from the diluted salt solution. In the second state (not shown) flows 56, 58 change position such that compartment 6 is provided with a diluted salt solution and compartment 22 is provided with a concentrated salt solution. The system 54 saves two membranes in comparison to system 34. The illustrated embodiment of system 54 with five cells is used in an experiment with the same conditions as described for previous experiments. The voltage was measured at 100 mA corresponding to 10 A/m² (FIG. 6, with a current of 100 mA for two cycles with the solid line showing the voltage over the stack in Volts, the dashed line showing the power density in W/m², and the dotted lines indicating the period with and without current, with time in seconds).

An alternative system 60 (FIG. 7) is provided with a first capacitive electrode 62 and corresponding compartment and a second capacitive electrode 64 and corresponding compartment. Capacitive electrodes 62, 64 and corresponding compartments comprise a cation exchanging membrane 66, a salt solution 68 and capacitive electrodes 4, 24. Compartments 6, 22 are provided with reference electrodes 72. In use compartments 6, 22 have the fluids maintained within the compartments and reference electrodes 72 check the voltage over each capacitive electrode. System 60 does not require circulating the electrode rinse solution.

The present invention is by no means limited to the above described and preferred embodiments. The rights sought are defined by the following claims, within the scope of which many modifications can be envisaged.

1. Energy generating system using capacitive electrodes, the system comprising:
a first electrode compartment provided with at least a first capacitive electrode capable to store ions and conduct electrons;
a second electrode compartment provided with at least a second capacitive electrode capable to store ions and conduct electrons;
a number of electrolyte compartments provided between the first and the second electrode compartments, wherein the electrolyte compartments are formed by a number of alternately provided cation exchange membranes and anion exchange membranes, whereby in use the electrolyte compartments are alternately filled with a high and low osmotic flow, such that the first and second electrodes are charged with positively or negatively charged ions;
a circuit connected to the at least first and second electrodes for collecting the generated energy; and
switching means for switching between the high and low osmotic flows such that the system switches from a first energy generating state to a second energy generating state with the first and second electrodes switching polarity.

2. Energy generating system according to claim 1, wherein the capacitive electrodes have a capacity of at least 1000 Farad per m² of electrode.

3. Energy generating system according to claim 2, wherein the capacitive electrodes have a capacity in the range of 1000-500000 Farad per m² of electrode.

4. Energy generating system according to claim 1, wherein in use the electrode compartments are filled with rinse solution.

5. Energy generating system according to claim 4, wherein the rinse solution is the high osmotic flow, the low osmotic flow and/or a mixture thereof.

6. Energy generating system according to claim 5, further comprising flow means such that in use the rinse solution in an electrode compartment is alternately the high osmotic flow and the low osmotic flow.

7. Energy generating system according to claim 4, wherein the rinse solution substantially remains within the electrode compartment.

8. Energy generating system according to claim 7, wherein at least one of the electrodes and/or electrode compartments comprises a salt solution.

9. Energy generating system according to claim 1, wherein the switching means comprise a first reference electrode in the first electrode compartment and a second reference electrode in the second electrode compartment.

10. Energy generating system according to claim 1, wherein the switching means comprise a pH-sensor.

11. Method for generating energy, comprising:
providing an energy generating system according to claim 1;
providing high and low osmotic flows in adjacent electrolyte compartments; and
switching between a first energy generating state and a second energy generating state, wherein high and low osmotic flows change position.

12. Method according to claim 11, wherein the capacitive electrodes store a surplus of either cations or anions in their porous structure thereby storing a net electrical charge.

13. Method according to claim 11, wherein energy generation continues directly after switching the flows when switching between the first and second energy generating states.

14. Method according to claim 11, wherein in use switching between the first and second energy generating state is performed in a range between 0-1000 minutes.

15. Energy generating system according to claim 3, wherein the capacitive electrodes have a capacity in the range of 10000-500000 Farad per m2 of electrode.

16. Method according to claim 14, wherein in use switching between the first and second energy generating state is performed in a range between 30-500 minutes.
